(19) United States
(12) Patent Application Publication
(10) Pub. No.: US 2015/0025898 A1
(43) Pub. Date: Jan. 22, 2015

(54) Systems And Methods Relating To Control Of Third Party Payment For Healthcare Products

(71) Applicants: Mohamad A. Bazzi, Dearborn, MI (US); William Kaafarani, Dearborn Heights, MI (US)

(72) Inventors: Mohamad A. Bazzi, Dearborn, MI (US); William Kaafarani, Dearborn Heights, MI (US)

(21) Appl. No.: 13/944,249

(22) Filed: Jul. 17, 2013

(51) Int. Cl. G06F 19/00

(52) U.S. Cl. CPC G06F 19/328
USPC 705/2

(57) ABSTRACT

Preventing multiple payment for healthcare product by a third party payor includes receiving an electronic request for third party payment, receiving electronic data indicative of an expected remainder of healthcare product in a serialized allotment, and comparing an amount of the healthcare product to be dispensed with the expected remainder. A payment fault is generated responsive to the comparison, such that payment for healthcare product already depleted from the serialized allotment is prevented.

### TECHNICAL FIELD

The present disclosure relates generally to electronic processing of requests for third party payment for healthcare products, and relates more particularly to authorizing or denying such a request responsive to an expected remainder of healthcare product in a serialized allotment.

### BACKGROUND

The healthcare industry has long been plagued by challenges in efficiently and cost effectively delivering healthcare products and services. Challenges such as fraud, abuse, waste and counterfeiting continue to fuel a seemingly inexorable rise in costs to pharmaceutical and other healthcare product manufacturers, healthcare service providers, dispensaries such as pharmacies, third parties bearing responsibility for payment, and of course patients themselves. Meanwhile, regardless of their real or perceived necessity, many laws and regulations of course apply throughout the complex web of modern healthcare, and for better or worse are regularly changing.

Legislative and administrative efforts exist at both the state and federal levels that attempt to address various perceived problems in the healthcare field. As is often the case, new or revised laws and rules will likely present some improvements but also the potential for the creation of obstacles to streamlining scientific and business processes toward the ultimate goals of providing high quality and affordable care.

So-called Pedigree laws are pending or passed in certain states, and propose enhanced requirements on monitoring and/or recording the location and handling of medications at or from their point of origin and throughout the chain of commerce to ultimate delivery to patients at a point of dispense. A goal of such enhanced tracking and traceability of medications is a reduced presence in the stream of commerce of counterfeit products.

In one proposed form Pedigree laws will require a unique code to be associated with individual packages of medication, presumably enabling computerized tracking of the location and handling of those packages from the manufacturer to the dispensary. In another form, unique codes may be associated with medication at the lot level. Delivery of medication to retailers and ultimately patients that is out and out fake or whose origin is improperly or fraudulently labeled, are problems that may ultimately be addressed by such laws. Otherwise sloppy, inaccurate or non-existent record keeping may also be improved.

The rise of computerized scanning/reading of codes, radiofrequency identification (RFID) tags, and inventory tracking technology in private enterprise are in part responsible for at least the perception that Pedigree laws will succeed. It is likely that continued development of computer software, hardware and automated systems will further support this proposition. Other areas of inefficiency and challenge in the healthcare system remain to be addressed, however.

### SUMMARY

In one aspect, a method of preventing multiple payments for a healthcare product by a third party payor includes receiving an electronic request for third party payment for a healthcare product to be dispensed to a patient at a dispensary, and receiving electronic data indicative of an expected remainder of the healthcare product in a serialized allotment in an inventory at the dispensary. The method further includes comparing an amount of the healthcare product to be dispensed with the expected remainder, and generating a payment fault responsive to the comparison, such that payment for healthcare product already depleted from the serialized allotment is prevented.

In another aspect, a method of controlling third party payment for a healthcare product includes receiving an electronic request for third party payment for a healthcare product to be dispensed to a patient. The method further includes querying a database storing data indicative of an expected remainder in a serialized allotment of the healthcare product in an inventory at a dispensary originating the request, and determining whether dispensing of the healthcare product can be satisfied from the serialized allotment responsive to the stored data. The method still further includes transmitting an electronic denial or authorization of the request responsive to the determination.

In still another aspect, a system for processing electronic requests for third party payment for healthcare products includes a computer configured to receive an electronic request originating at a dispensary for healthcare products and transmitted over a communications network, for third party payment for a healthcare product to be dispensed to a patient. The request encodes a serial identifier unique to a serialized allotment of the healthcare product in an inventory at the dispensary. The computer is further configured to receive data indicative of an expected remainder in the serialized allotment, and to compare the expected remainder with an amount of the healthcare product to be dispensed. The computer is further configured to generate a payment fault where the expected remainder is insufficient to satisfy an amount of the healthcare product to be dispensed, and to responsively transmit an electronic denial of the request over the communications network, such that payment for healthcare product already depleted from the allotment is prevented.

### BRIEF DESCRIPTION OF THE DRAWINGS

FIG. 1 is a system level diagram of progression of healthcare product through a supply chain, and communication aspects relating thereto, according to one embodiment;

FIG. 2 is a diagrammatic view of a standardized container for healthcare product, according to one embodiment;

FIG. 3 is a system level functional diagram at one stage of processing a request, according to one embodiment;

FIG. 4 is a system level functional diagram at another stage of processing the request, according to one embodiment;

FIG. 5 is another system level functional diagram at one stage of processing a reversal request, according to one embodiment;

FIG. 6 is a system level functional diagram at another stage of processing the reversal request, according to one embodiment;

FIG. 7 is a flowchart illustrating steps in processing a request, according to one embodiment;

FIG. 8 is a flowchart illustrating steps in a process executed in connection with the processing of FIG. 7; and

FIG. 9 is another flowchart illustrating steps in processing a reversal request, according to one embodiment.

### DETAILED DESCRIPTION

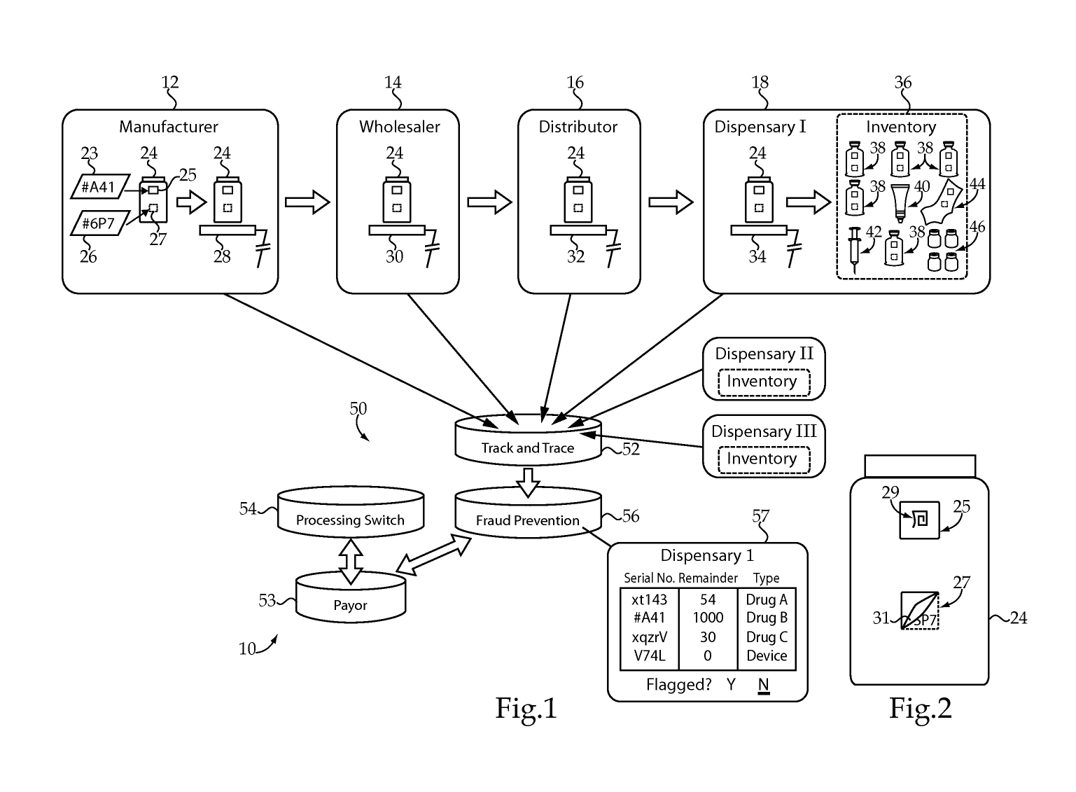

Referring to FIG. 1, there is shown a system level functional diagram 10 illustrating progression of healthcare product through a supply chain, and among other things various aspects of electronic communication between and among supply chain participants and a computer system 50 in accordance with the present disclosure. Those skilled in the art will be familiar with proposed and enacted jurisdictional requirements as to serialization of healthcare products and the exploitation of such serialization to track and trace healthcare product at the lot level or at the individual package level through their various commercial channels. The purpose of such serialization and the tracking and tracing enabled thereby is at least predominantly protection of patients from counterfeit products, notably counterfeit medication. As will be further apparent from the following description, the present disclosure enables serialization to be exploited for different ends, among them the reduction of fraud, waste, and other problems relating but not limited to inappropriate billing for healthcare products to third party payors.

In FIG. 1, block 12 identifies a manufacturer where a standardized container 24 for a healthcare product such as a medication will typically be filled, and forwarded to a wholesaler 14. From wholesaler 14, container 24 may be forwarded to a distributor 16, and then delivered to a plurality of dispensaries, including for example dispensary I at block 18, dispensary II at block 20 and dispensary III at block 22. This general supply chain from manufacturer 12 to dispensaries 18, 20 and 22 is of course exemplary only, and other entities may be involved in the ultimate delivery of healthcare products from an original source to points from which those healthcare products are dispensed. For instance, a packager or repackager might receive healthcare products from the manufacturer 12 and deliver them to the wholesaler 14. Additional distributers might be involved, and the number of dispensaries could of course be quite large. As used herein, the term “dispensary” refers to any location from which healthcare products are dispensed to patients, including retail pharmacies open to the public, private or institutional pharmacies, nursing homes, and potentially even retail medical supply outlets. Each of the entities in the supply chain from manufacturer 12 to and including dispensaries 18, 20 and 22 may be in communication with a computer system 50. Computer system 50 may include a track and trace component 52, a fraud prevention component 56, a processing switch component 54 and a third party payor component 53. The term “fraud prevention” is illustrative only and refers to one of several potential functions of component 56, although the prevention of fraud is expected to be one advantageous application of the teachings set forth herein. Each of these components may include one or more computers which may include server computers, and suitable computer readable memory for storing data in a retrievable form in a manner and for purposes further discussed herein. In one practical implementation strategy, track and trace component 52 may include a so-called Pedigree database as discussed above, which may receive information from all of the entities in the supply chain.

To this end, each of the entities in the supply chain may gather certain information from container 24, and forward that information to track and trace component 52. The information of interest relating to container 24 can include a serial identifier, a second identifier, information such as the contents of container 24, the location at which the information is being gathered, a time stamp, and potentially still other data relating to passage of container 24 through the supply chain. In one practical implementation strategy, container 24 includes an electronically readable medium 25 shown at manufacturer 12, upon which is stored a serial identifier 23. Container 24 may contain a serialized allotment of a healthcare product, such as a number of pills of medication. Identifier 23 may be unique to the allotment of medication that container 24 is configured to contain. Manufacturer 12 may be the point in the supply chain at which identifier 23 is first stored on medium 25, however in other instances a contractor or another party could be employed. Manufacturer 12 is equipped with a reading device such as a scanner 28 that can read identifier 23 from container 24, and forward the electronically read identifier plus additional information noted above for storing on track and trace component 52. Similar reading and forwarding of information can occur at wholesaler 14, distributor 16, and each of dispensaries 18, 20 and 22. Wholesaler 14, distributer 16 and dispensary I at block 18 are each equipped with scanners 30, 32 and 34 for these purposes.

In one embodiment, medium 25 may include a so-called RFID tag, having suitable electronic circuitry and/or an antennae 29 as shown in FIG. 2. In other embodiments, medium 25 might include a barcode, a magnetic stripe, or any other suitable electronically readable medium. In a practical implementation strategy, serial identifier 23 may include a numeric code, unique to the allotment contained in container 24. Additional information could be stored on medium 25, including electronically stored data as to the date of manufacture, the manufacturer, an identity of the healthcare product in the allotment, data relating to the manufacturer or source of container 24 itself, and virtually any additional conceivable information relating to container 24 or the allotment of healthcare product contained therein.

In certain embodiments, the information stored on medium 25 might be updated and/or supplemented at additional stages in the supply chain. For example, when container 24 is forwarded to wholesaler 14 from manufacturer 12, wholesaler 14 might store on medium 25 information such as the time and date of receiving container 24, the time at which it is scanned and information forwarded to track and trace component 52, the identity of the party that transported container 24 from manufacturer 12 to wholesaler 14, or still other information. Analogous updating of medium 25 might occur at distributor 16, and at any of the dispensaries.

Container 24 might include a second electronically readable medium 27 that stores a second, security identifier 26. Identifier 26 may also include a numeric identifier, but could be some other type of security identifier. In one practical implementation strategy, when a database at track and trace component 52, or at components 53 or 56, is populated with information sent from manufacturer 12 respecting container 24, a database record can be stored that includes both serial identifier 23 and security identifier 26. The database may ultimately be populated with a plurality of records each linked with a serial identifier unique to one of a plurality of allotments of healthcare products in an inventory at a dispensary. Serial identifier 26 may be obscured at the manufacturer, or otherwise rendered difficult to read by intermediate entities, and security identifier 26 only electronically read or read by personnel once container 24 is opened to fill an order at one of the dispensaries, as further discussed herein. In FIG. 2, medium 27 is shown partially obscured by a covering 31. Covering 31 might be a peel-away label that is pulled back to enable a scanner or a person at a dispensary to read identifier 26.

As noted above, container 24 may include a stock bottle that contains an allotment of medication, such as a predetermined number of pills. When container 24 arrives at a dispensary, it may be scanned and the identifier stored on medium 25, as well as other information, forwarded to track and trace component 52. From this point, container 24 may be placed in an inventory at the dispensary. In connection with dispensary I in FIG. 1, the inventory is identified with reference numeral 36. When a patient presents a prescription for filling with the medication contained in container 24, container 24 may be opened and the prescription filled from its contents. Subsequent prescriptions may be filled from container 24 until its contents are depleted, and then a new container from inventory 36 can be used. As further discussed herein, the present disclosure contemplates a unique strategy for remotely monitoring what is expected to remain in container 24. In this way, a third party payor can track the depletion of medication from the allotment within container 24, and thus determine if medication that has been previously paid for is being used to fill a prescription and used again by a dispensary in intentionally or inadvertently seeking a duplicate payment. Another way to understand this general principle is that payor 53 by way of strategies set forth herein can track depletion of a healthcare product such as medication from a serialized allotment, and if an attempt is made to charge payor 53 a second time they can deny the claim.

Container 24 is only one of a number of types of containers that may be resident in inventory 36. In addition, a number of units of medication within container 24 is only one type of serialized allotment contemplated herein. Inventory 36 may include a plurality of additional stock bottles 38 each configured similarly to container 24 to contain a serialized allotment. In addition, inventory 36 may include medication such as creams in the form of a tube 40, or dispensable from a stock bottle or canister or the like, orthopedic devices such as an ankle brace 44, syringes 42, and medications stored in vials 46 or blister packs and prepackaged for delivery to a patient. In one practical implementation strategy, all the contents of inventory 36, or many of the healthcare products contained therein, may be serialized via serial identifiers unique to an allotment. In the case of syringes, for instance, rather than a single stock bottle having a unique serial identifier and containing an allotment, a serial indentifier might be applied at the lot level such that an allotment of syringes are not each individually and uniquely identified, but as a group have an associated unique serial identifier. Similar principles apply to prepackaged vials 46, orthopedic devices, and virtually any other conceivable product available at a dispensary. The principles of tracking depletion of an allotment, and detection of fraudulent or otherwise inappropriate billing, can be expected to apply regardless of the type of healthcare product concerned. The commercial application of these various principles will be further understood in view of the examples discussed below.

As previously noted, system 50 may include a number of different components. In FIG. 1, bidirectional communication is shown between payor component 53 and fraud prevention component 56. Unidirectional communication is shown between fraud prevention component 56 and track and trace component 52. In one embodiment, fraud prevention component 56 is configured to access the stored databases at track and trace component 52, for purposes consistent with controlling third party payment and preventing multiple payments for healthcare products as discussed herein. Processing switch component 54, known in the art as a switchboard, is shown in bidirectional communication with payor component 53. It should be appreciated that the communicative aspects of system 50 are exemplary only. Component 56 may perform various data processing functions on behalf of component 53, and could receive data for processing from component 53 directly and then forward back the results to component 53. Alternatively, component 56 might be in direct communication with dispensaries 18, 20, and 22, and could even conceivably be in communication with the entities in the supply chain such as manufacturer 12, wholesaler 14 and distributor 16.

It will thus be appreciated that a variety of different communication architectures among various computer system components could fall within the scope of the present disclosure. Moreover, the data processing that leads to authorizing or denying claims for third party payment could be carried out at component 56, or at component 53, or still another participant. Moreover, while it is contemplated that track and trace component 52 may store data which is accessed by component 56, in certain instances component 56 could store all the pertinent data which is fed to component 52 from the entities in the supply chain. Rather than a database having a single physical location, whether that database is considered part of component 52, component 53, or component 56, a distributed database system such as a cloud computing distributed database could be used.

In FIG. 1, a database record 57 is shown which might be stored at component 56, or retrieved by component 56 from elsewhere. Database record 57 may be associated with dispensary I in certain embodiments, and could be one of many database records each associated with a different dispensary. Database record 57 may further include information relating to a plurality of healthcare product types, such as Drug A, Drug B, Drug C, and a device. Linked with the data as to product type may be a serial identifier unique to the allotment of that corresponding product in inventory 36. Linked also with the serial identifier may be an expected remainder of that product type in the corresponding allotment. In database record 57, Drug A is associated with serial no. XT143, and has an expected remainder of 54. Where Drug A is a medication in pill form, the expected remainder may indicate a number of pills that are presumed to be remaining in the corresponding allotment. As prescriptions are filled for Drug A, component 56 can draw down the expected remainder, in the case of pills subtracting a number of pills used to fill a given prescription from the expected remainder. As electronic requests for payment are authorized, component 56 will draw down the expected remainder accordingly, until reaching zero. Also shown in record 57 is a device corresponding to allotment V74L, where the remainder is zero. This entry in record 57 could correspond to a finite number of devices in the corresponding allotment, where the expected remainder is drawn down by exactly one each time one of the devices in the allotment is dispensed. In the case of an allotment with a starting capacity equal to exactly one, component 56 could update record 57 by drawing down the expected remainder from one to zero when that single device or other product is dispensed and/or paid for.

Those skilled in the art will be familiar with many of the commonly exploited opportunities for fraudulent or otherwise inappropriate billing. In the case of prescription medication in pill form, it was previously well known that certain dispensaries could at least theoretically dispense medication to a patient, bill the third party payor such as an insurance company, Medicare or Medicaid, but then later find that the patient did not pick up the medication. Alternatively, the patient might return the medication unopened, or even perhaps return an unused portion. Standard protocol mandates that at least where medication has passed into the custody of the patient, it cannot be returned to inventory. It has previously been nevertheless possible for such unused or returned medication to be repackaged for another patient, dispensed again, and the third party payor duplicatively billed. In other instances, patients might have unused refills, which are never actually dispensed to a patient, but used to fraudulently bill a third party payor as if that medication were actually dispensed. Without any means to track the depletion of medication from standardized containers, for example, third party payors have had virtually no way to prevent such practices. In the case of other healthcare products, certain of such products might be intended as single use, but after use by one patient and a first bill sent to a third party payor, such products might be dispensed again. Still another example relates to medication that can be dispensed in different size amounts, such as certain medication creams. A dispensary might bill a third party payor for a large tube of medication cream, for example, but dispense to a patient only a small tube. In light of the foregoing examples, it will be appreciated that prior practices have presented ample opportunities for inappropriate billings through fraud and mistake.

The tools available to third party payors to combat the above practices have heretofore been fairly limited. A principle strategy employed by third party payors has been the practice of random audits of dispensaries. In general, a third party payor or its agents will request access to the inventory in a dispensary, and go through piece by piece analysis of what is in the inventory, compare with what has been claimed to be taken out of inventory, and attempt to detect discrepancies that are not readily explained. Audit practices can be affective, but tend to require substantial time, effort and expense on the part of third party payors. In FIG. 1, record 57 may also include information as to whether the corresponding dispensary is flagged. It is contemplated that one application of the present disclosure will be flagging certain dispensaries for auditing, based upon the detection of actual or suspected inappropriate billing practices. In one example, component 56 will update record 57 to reflect the generation of a payment fault, further discussed herein, which is generated in response to detection of actual or suspected inappropriate billing. As a result, auditing of dispensaries or perhaps even other entities in the supply chain either by third party payors or regulatory agency personnel, can be targeted based upon data in stored transaction histories associated with each of those dispensaries, or the simple presence of a flag set by the computer in component 56 responsive to payment faults or patterns or numbers of payment faults over time, as further discussed herein.

Referring now to FIG. 3, there are shown additional functional and system level features relating to processing requested third party payment for a healthcare product to be dispensed to a patient at a dispensary. At dispensary 18, a computer station 60 is shown having a display 62 illustrated as it might appear where a plurality of different fillable data fields are displayed to an attendant such as a pharmacist or technician. The fillable fields shown on display 62 represent data entry fields that are filled out by the attendant in connection with submitting a request 78 for third party payment such as an insurance claim. The fillable fields include a security identifier field, a patient identifier field, a manufacturer field, a medication field, a quantity field, a doctor field, and an allotment identifier field. The security identifier field may be filled via an input device 64, as may the other fields, with the identifier made visible by peeling back covering 31 to reveal the identifier on medium 27. The attendant might visually read the identifier, but could also read the identifier with a scanner or the like. Instead of a peel-away covering, covering 31 might include a scratch off covering, a barcode, or any other suitable obscurable or not readily visible code as discussed herein. In still further embodiments, the security identifier might include an identifier only visible when exposed to ultraviolet light, for example, or could even be a feature of container 24 itself such as a color by which container 24 fluoresces when exposed to particular wavelengths of light. Still other embodiments might include a plurality of different security identifiers resident on container 24, and one used each time that medication is dispensed to a patient from container 24.

The patient identifier might include an insurance policy number or other identifier unique to the patient to whom the medication is to be dispensed. The manufacturer field may be the manufacturer of the medication, the medication field may be the medication type, the quantity field could be the quantity to be dispensed, the doctor field will typically be the name or DEA number of the prescribing physician, and the allotment identifier field may include the serial identifier unique to the allotment contained in container 24. To this end, the allotment identifier 23 is shown forwarded from a scanning mechanism 72, which could be the same or different from scanning mechanism 34, in proximity to container 24. Container 24 is shown removed from inventory 36 and placed upon scanning mechanism 72, but of course could be scanned via a handheld scanner or the like while remaining physically within inventory 36. Also shown at dispensary 18 is a scale 66, upon which container 24 can be placed before or after scanning allotment identifier 23 via scanning mechanism 72. Weight/quantity data 68 is shown forwarded from scale 66 along with allotment identifier 23 to computer station 60, and could be encoded in request 78. Other strategies for determining an approximate quantity, while optional, could be used. Quantity data could be evaluated at component 56 as a cross check against the expected remainder. Also shown is a retail vial 74 within which a quantity of medication from container 24 is placed or is to be placed for ultimately delivering to the patient. Vial 74 may include a label encoding or otherwise having printed thereon the allotment identifier, and potentially additional information. Those skilled in the art will appreciate that an insurance claim or the like filled out at computer station 60 could include more information or less information than that which is illustrated in FIG. 3. It is likely that a date of the transaction, and an identification number for the originating dispensary, whether a new prescription or a refill is requested to be paid for, or still additional information would be included. Any suitable software stored in memory at computer station 60, or remotely stored software as a service (SAAS), could be used at computer station 60 to create and transmit the request. A fillable PDF form, xml, DOS, or any other suitable format and/or platform can be used.

In any event, computer station 60 may generate and transmit electronic request 78 for third party payment for the healthcare product to be dispensed to a patient at dispensary 18 over a communications network 58. Network 58 may include any private or public network, wireless or wired. Request 78 may first arrive at processing switch component 54 and may then be forwarded on to payor component 53. Payor component 53 may forward the request in a raw or modified format to fraud prevention component 56, which may perform data processing to determine whether request 78 is to be authorized or denied, and may be configured to authorize or deny the request on the payor's behalf. It will be recalled that fraud prevention component 56 may include or be configured to access a database storing data indicative of an expected remainder of the healthcare product in a serialized allotment in inventory 36 at dispensary 18. Fraud prevention component 56 may receive the subject electronic data from its own database or another database, and forward that electronic data back to payor component 53, or might itself perform the processing of the data as noted above to determine whether request 78 is to be authorized or denied.

In either case, whether the data processing is performed at payor component 53 or fraud prevention component 56, the subject database is queried responsive to the serial identifier encoded in the request, and a computer may compare an amount of the healthcare product to be dispensed with the expected remainder. In the case of a requested number of medication units such as pills, the comparison may include comparing a number of the pills to be dispensed with a number in the expected remainder. Where the medication is instead stored in retail package level units, or the healthcare product is a medical device or the like, the comparison may include comparing an amount equal to one with a remaining capacity in the expected remainder, which could be one or zero. In still other embodiments, the data indicative of an expected remainder could include a list of serial numbers for a finite number of units of healthcare product not yet depleted from a serialized allotment.

Rather than comparing exact numbers, an estimate might be used, for example making use of the fact that certain medications are often dispensed in standard amounts. In other words, rather than storing an actual number of pills as the expected remainder, a more quantitative or a qualitative analysis might be used, and the subject database could be queried as to whether about 10% of the serialized allotment remains, about 20%, or some other quantitative or qualitative factor. In a related vein, some tolerance for error might be permitted. For instance, if a requested amount of the medication to be dispensed is from, say, 20-50 units, and the database record indicates that the expected remainder is from say 10 units to 100 units, the request might be approved. Still other strategies of not requiring perfection in counting on the payor's end or the dispensary's end will be apparent to those skilled in the art, and thus the description herein of comparing an amount with an expected remainder will be understood to encompass not only strict comparison of exact numbers but also fuzzier comparisons of a more general range of amounts with a general remaining capacity.

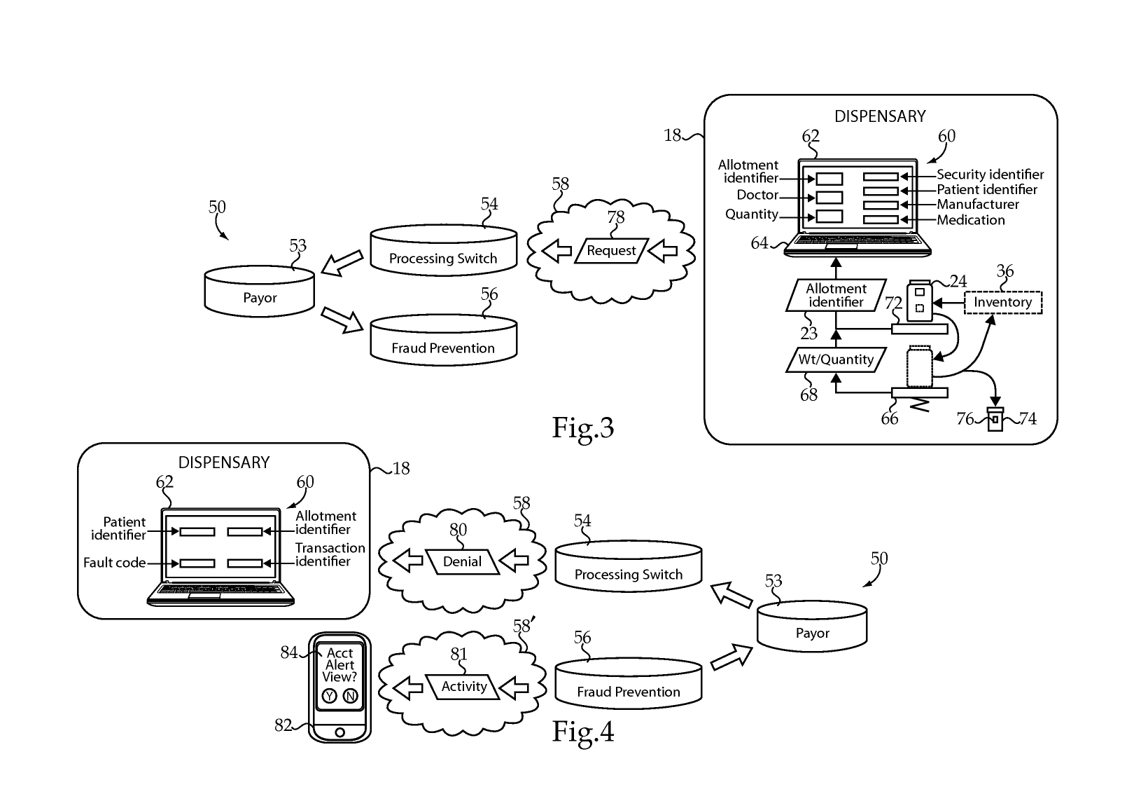

Referring also now to FIG. 4, there is shown system 50 and dispensary 18 where fraud prevention component 56 has communicated back to payor component 53 that a problem exists with the request. At fraud prevention component 56 or at payor component 53 a payment fault may be generated responsive to the comparison, forwarded via processing switch component 54 back to dispensary 18 in the form of an electronic denial 80 transmitted via communications network 58. Generating the payment fault in this manner can prevent payment for healthcare product already depleted from the serialized allotment. Electronic denial 80 is received back at dispensary 18, and computer station 60 may be responsively operated to display various denial of request parameters in a transaction record on display 62. Such parameters may include the same patient identifier and allotment identifier encoded in the electronic request, and also a fault code encoded in the electronic denial. In a practical implementation strategy, denial 80 may encode a fault code indicative of one of a finite number of reasons for the payment fault. Such reasons could include, for example, the expected remainder being insufficient to satisfy an amount of the healthcare product to be dispensed. The fault code could also encode reasons for the denial relating to inability to locate the subject patient identifier or the allotment identifier in the database, a failure of pre-authorization, or any of a number of other reasons. Denial 80 may also encode a transaction identifier which is displayed on display 62 as well.

In parallel or subsequent to generating a payment fault and denying the request, a patient may be alerted via an alert on a display 84 of a handheld electronic device 82 such as a so-called smart phone or the like. In one practical implementation strategy, fraud prevention component 56 may transmit an activity alert 81 via the same or another communications network 58′ to device 82. It is contemplated that notifying a patient of activity on their account, whether it be denial of a request for third party payment or authorization of a request for third party payment, can be advantageous from the standpoint of involving the patient directly in the processing of third party payment requests for their account. Patient participation also raises the probability that fraudulent or otherwise inappropriate billing practices might be detected by the patient, who could in turn notify the third party payor that something appears to be amiss.

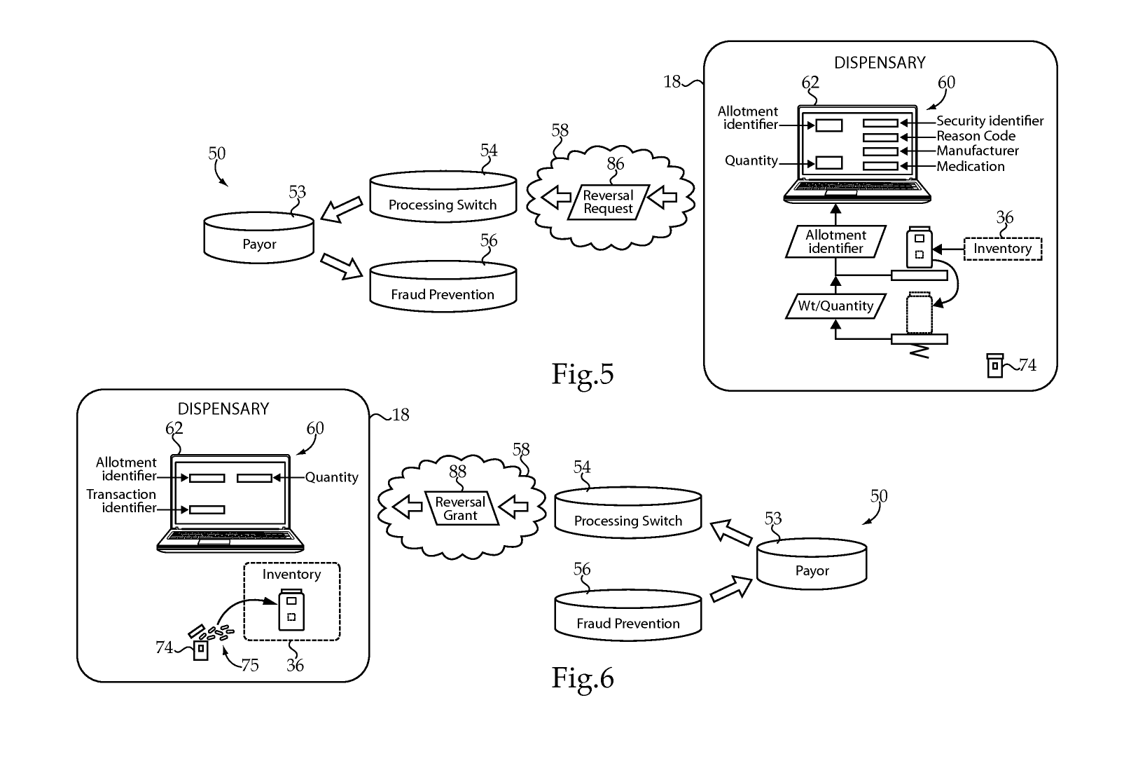

Referring now to FIG. 5, there is shown an electronic reversal request 86 being transmitted from dispensary 18 to system 50, which reversal request is analyzed via fraud prevention component 56. Retail vial 74 is shown at dispensary 18, and might have been paid for by the third party payor but never picked up by a patient. The present disclosure contemplates reversing claims so that the serialized allotment can be replenished with medication or another healthcare product which might need to be discarded or is otherwise problematic or impossible to return to inventory. Computer station 60 is shown as it might appear where the reversal request is generated via filling in various fields, including manufacturer, medication, quantity, allotment identifier, and security identifier fields analogous to these fields described in connection with FIGS. 3 and 4. In addition, a reason code field may be filled such that reversal request 86 encodes the reason code, corresponding to an asserted reason that reversal request 86 is being generated.

In FIG. 6, system 50 has transmitted a reversal grant 88 back to computer station 60 at dispensary 18. The reversal grant may encode a transaction identifier, the allotment identifier and a quantity identifier, informing an attendant at dispensary 18 what quantity of medication or the like can be returned to container 24 or otherwise replenished to the serialized allotment. In FIG. 6, medication pills 75 are shown removed from retail vial 74 and forwarded back to inventory 36.

### INDUSTRIAL APPLICABILITY

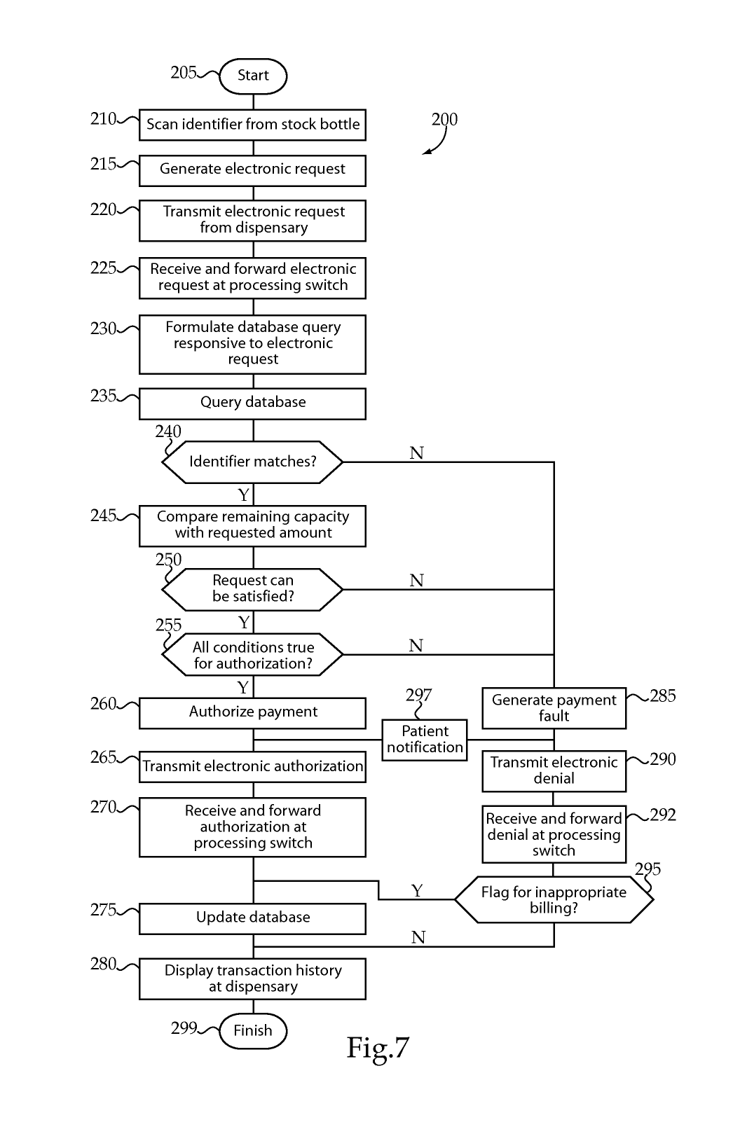

Referring to FIG. 7, there is shown a flowchart 200 illustrating example methodology including control logic according to the present disclosure. The process of flowchart 200 may commence at step 205, and then advance to step 210 to scan a serial identifier from a stock bottle. From step 210, the process may advance to step 215 to generate the electronic request, and to step 220 to transmit the electronic request from the dispensary. Rather than scanning the serial identifier, it could be read visually by personnel at the dispensary and manually entered to generate the electronic request. From step 220, the process may advance to step 225 to receive and forward the electronic request at the processing switch component. From step 225 the process may advance to step 230 where a computer at payor component 53 or at fraud prevention component 56 formulates a database query responsive to the electronic request. The database query will typically be formulated to retrieve electronic data in a stored record linked with the serial identifier. From step 230, the process may advance to step 235 to query the database, and then to step 240 to determine whether the serial identifier matches, in other words whether the serial identifier or its database record can be found in the database. If no, the process may advance to step 285 to generate a payment fault.

If, at step 240, the identifier matches, the process may advance to step 245 to compare the remaining capacity or otherwise compare the expected remainder in the serialized allotment with the requested amount, in other words an amount of medication to be dispensed and typically encoded in the electronic request. From step 245, the process may advance to step 250 to determine whether the request can be satisfied. If no, the process may advance to step 285 to generate a payment fault. If yes, the process may advance to step 255 to determine whether all conditions are true for authorization. If no, the process may advance to step 285. If yes, the process may advance to step 260 to authorize payment. From step 260, the process may advance to step 265 to transmit the electronic authorization, such as from payor component 53 or fraud prevention component 56. From step 265, the process may advance to step 270 to receive and forward the authorization at the processing switch such as processing switch component 54. From step 270, the process may advance to step 275 to update the database. In a practical implementation strategy, upon authorizing third party payment, the database may be updated to draw down the expected remainder responsive to an amount of medication dispensed. The database may also be updated responsive to a payment fault, as further discussed herein. From step 275, the process may advance to step 280 to display a transaction history at the dispensary, such as a transaction history relating to denial or authorization of the request for third party payment as discussed herein, and may finish at step 299.

If, at any stage, the processing proceeds to step 285 to generate a payment fault, the process may advance to step 290 to transmit an electronic denial as discussed herein. From step 290, the process may advance to step 292 to receive and forward the denial at the processing switch. From step 292 the process may advance to step 295 to determine whether a flag should be set for inappropriate billing. In one example embodiment, the determination at step 295 could include determining whether a threshold number of payment faults have been generated responsive to requests from a certain dispensary, or a threshold number generated within a certain time, or some other set of conditions justifying setting a flag for inappropriate billing. From step 295, if no flag is to be set the process may advance to step 280. If the flag for inappropriate billing is to be set, the process may advance to step 275 to update the database accordingly, such as by flipping the stored status in a database record for the dispensary from a no state to a yes state. Flowchart 200 further includes block 297 which corresponds to a patient notification component of the process. It may be noted that patient notification component 297 may be executed where a payment is authorized as per step 260 or a payment fault is generated as per step 285. Embodiments are contemplated in which the patient notification component is part of the request processing, although the patient may not directly take part in the process at all.

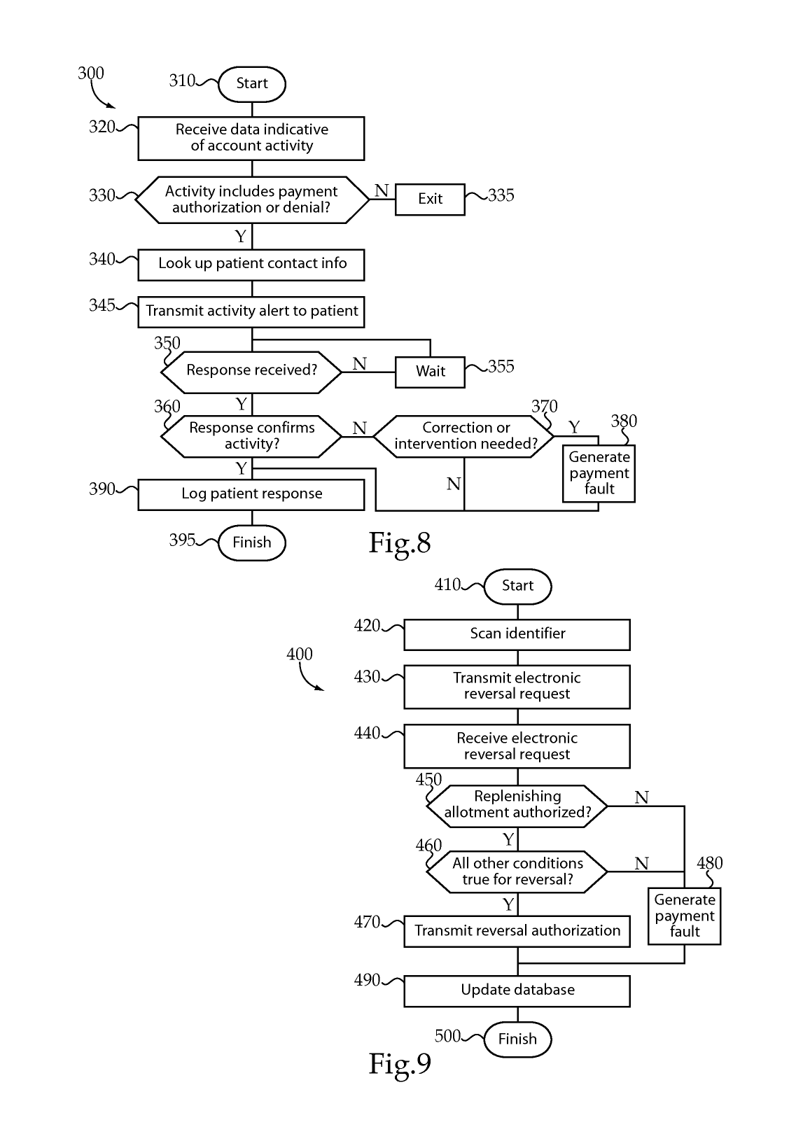

Referring now to FIG. 8, there is shown a flowchart 300 illustrating processing steps including control logic relating to patient notification component 297 shown in FIG. 7. The process of flowchart 300 may start at step 310, and advance to step 320 to receive data indicative of account activity. The receipt of data at step 320 might include receipt by a computer at fraud prevention component 56 or payor component 53, or potentially even processing switch component 54. In any event, at step 320 data indicative of activity connected to the account of a patient having a unique patient identifier as discussed herein is received on a computer, and the process may advance to step 330 to determine whether the activity includes a payment authorization or denial. If no, the process may exit at step 335. If yes, the process may advance to step 340 where the computer looks up patient contact information such as a phone number or email address. From step 340, the process may advance to step 345 to transmit an activity alert to the patient, such as an email, a text message, or an automated phone call. From step 345, the process may advance to step 350 to determine whether a response was received. If no, the process may wait at step 355 and loop back to execute step 350 again, or could exit. If yes, the process may advance to step 360 to determine whether the response confirms the activity.

As shown diagrammatically in FIG. 4, the patient can be provided an account alert, presenting the option of whether the patient wishes to view the account alert or not. If the patient chooses yes, they could be taken to another screen where they are prompted to send a response message indicating that account activity should be confirmed or not. If, at step 360, the response does not confirm the activity, the process may advance to step 370 to determine whether correction or intervention is needed. The correction or intervention could depend upon the type of activity, and in the case of a denied request for payment could justify the computer automatically contacting the originating dispensary, or even regulatory authorities. Where a request is granted, but the patient indicates in their response that such activity was improper, a message might be forwarded to the originating dispensary instructing them to stop the transaction, or take some other corrective action. In any case, the subject transaction could be flagged for follow up by personnel, at either the third party payor or the dispensary for example. If correctional intervention is needed at step 370, the process may advance to step 380 to generate a payment fault, and then to step 390. If no correction or intervention is needed, the process may advance directly to step 390. At step 390, the patient's response can be logged in the database, and the process may finish at step 395.

Referring now to FIG. 9, there is shown another flowchart 400 illustrating example processes and control logic in connection with reversing a claim. The process may commence at step 410, and them proceed to step 420 to scan the serial identifier unique to a serialized allotment as discussed herein. From step 420, the process may advance to step 430 to transmit the electronic reversal request, and then to step 440 where the electronic reversal request is received. From step 440, the process may advance to step 450 to determine whether replenishing the subject allotment is authorized. If no, the process may advance to step 480 to generate a reversal fault. If yes, the process may advance to step 460 to determine whether all other conditions are true for reversal. If no, the process may advance to step 480. If yes, the process may advance to step 470 to transmit the reversal grant or authorization. From step 470, the process may advance to step 490 to update the database, adding back to the expected remainder where the reversal was authorized. In the case of a reversal fault being generated at step 480, updating the database at step 490 might include logging the reversal fault in a database record associated with the originating dispensary. As is the case with denials of requests for third party payment, denials of requests for reversal could also represent information or patterns of behavior useful in evaluating dispensaries and their billing practices. Dispensaries requesting frequent reversals, such as a threshold number within a given time period or a threshold number in a time period and associated with a particular medication, might be flagged for auditing.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of preventing multiple payments for a healthcare product by a third party payor comprising the steps of:
receiving an electronic request for third party payment for a healthcare product to be dispensed to a patient at a dispensary;
receiving electronic data indicative of an expected remainder of the healthcare product in a serialized allotment in an inventory at the dispensary;
comparing an amount of the healthcare product to be dispensed with the expected remainder; and
generating a payment fault responsive to the comparison, such that payment for healthcare product already depleted from the serialized allotment is prevented.

2. The method of claim 1 wherein the healthcare product includes a medication, and the step of receiving an electronic request further includes receiving an electronic request encoding the amount of the medication to be dispensed and a serial identifier unique to the serialized allotment.

3. The method of claim 2 further comprising the steps of reading the data from a database record linked with the serial identifier, and reducing the expected remainder responsive to a prior authorization of an electronic request for third party payment.

4. The method of claim 1 further comprising the steps of updating a database record associated with the dispensary responsive to the payment fault.

5. The method of claim 4 wherein the step of updating further includes setting a flag for inappropriate billing by the dispensary responsive to the payment fault.

6. The method of claim 1 further comprising a step of transmitting an electronic denial of the request responsive to the payment fault.

7. The method of claim 6 wherein the electronic denial encodes a fault code indicative of one of a finite number of reasons for the payment fault.

8. The method of claim 6 wherein the step of receiving an electronic request further includes receiving an electronic insurance claim request originating from the dispensary and encoding a patient identifier.

9. A method of controlling third party payment for a healthcare product comprising the steps of:
receiving an electronic request for third party payment for a healthcare product to be dispensed to a patient;
querying a database storing data indicative of an expected remainder in a serialized allotment of the healthcare product in an inventory at a dispensary originating the request;
determining whether dispensing of the healthcare product can be satisfied from the serialized allotment, responsive to the stored data; and
transmitting an electronic denial or authorization of the request responsive to the determination.

10. The method of claim 9 wherein the step of receiving an electronic request further includes receiving an electronic insurance claim request encoding a patient identifier, on a computer configured to deny or authorize the request on behalf of the third party.

11. The method of claim 9 further comprising a step of generating a payment fault where an amount of the healthcare product to be dispensed exceeds the expected remainder.

12. The method of claim 11 further comprising the steps of transmitting the electronic request from the originating dispensary, encoding in the electronic request a serial identifier unique to the serialized allotment, and displaying a transaction record on a computer display at the originating dispensary responsive to the payment fault.

13. The method of claim 10 further comprising a step of populating the database with a plurality of records each linked with one of a plurality of serial identifiers each unique to one of a plurality of serialized allotments of healthcare products in the inventory.

14. The method of claim 13 wherein the electronic request encodes one of the plurality of serial identifiers, and wherein the step of querying further includes querying the database responsive to the encoded serial identifier.

15. The method of claim 14 wherein the healthcare product includes a medication and the plurality of serial identifiers are each unique to one of a plurality of standardized medication containers in the inventory each configured to contain one of the plurality of serialized allotments.

16. The method of claim 16 wherein the plurality of serial identifiers each include a visible serial identifier resident in an electronically readable form on each one of the plurality of standardized medication containers, and wherein each of the medication containers further includes a non-visible security identifier also unique to one of the plurality of serialized allotments.

17. The method of claim 10 wherein the step of transmitting further includes transmitting an electronic authorization of the request, and further comprising a step of drawing down the expected remainder responsive to the authorization.

18. A system for processing electronic requests for third party payment for healthcare products comprising:
a computer configured to receive an electronic request originating at a dispensary for healthcare products and transmitted over a communications network, for third party payment for a healthcare product to be dispensed to a patient, the request encoding a serial identifier unique to a serialized allotment of the healthcare product in an inventory at the dispensary;
the computer being further configured to receive data indicative of an expected remainder in the serialized allotment, and to compare the expected remainder with an amount of the healthcare product to be dispensed; and
the computer being further configured to generate a payment fault where the expected remainder is insufficient to satisfy an amount of the healthcare product to be dispensed, and to responsively transmit an electronic denial of the request over the communications network, such that payment for healthcare product already depleted from the serialized allotment is prevented.

19. The system of claim 18 further comprising a plurality of standardized containers each configured to contain a serialized allotment of one of a plurality of different healthcare products, and each of the standardized containers having resident thereon an electronically readable medium storing a serial identifier unique to the corresponding serialized allotment.

20. The system of claim 19 wherein the computer includes a server computer, and the system further includes a retail computer configured to transmit the electronic request, and an electronic scanner in communication with the retail computer and configured to electronically read the stored serial identifiers for encoding in the electronic request.
